(19) United States
(12) Patent Application Publication
(10) Pub. No.: US 2012/0006998 A1
(43) Pub. Date: Jan. 12, 2012

(54) CONFIGURATIONS OF USING A POINT LIGHT SOURCE IN THE CONTEXT OF SAMPLE SEPARATION

(75) Inventor: Karsten Kraiczek, Waldbronn (DE)

(73) Assignee: AGILENT TECHNOLOGIES, INC., Loveland, CO (US)

(21) Appl. No.: 12/830,847

(22) Filed: Jul. 6, 2010

(51) Int. Cl. H01J 27/24; H01J 27/00

(52) U.S. Cl. 250/423 P; 250/423 R

(57) ABSTRACT

A sample detection apparatus for detecting a fluidic sample in a flow cell of a sample separation system, the sample detection apparatus comprising an electromagnetic radiation source having a chamber configured for generating a plasma, and an energy source configured for generating and directing an energy beam towards the plasma for heating the plasma so that the plasma emits primary electromagnetic radiation, and a detection path being arranged in a detection direction, wherein the detection direction is arranged angularly displaced with respect to a propagation direction of the energy beam, so that primary electromagnetic radiation propagating in the detection direction enters the detection path, wherein the detection path comprises an electromagnetic radiation detector configured for detecting secondary electromagnetic radiation being characteristic for the fluidic sample and resulting from an interaction between the fluidic sample and the primary electromagnetic radiation propagating in the detection direction or at least a portion thereof.

### BACKGROUND OF THE INVENTION

The present invention relates to sample detection using a flow cell.

In liquid chromatography, a fluidic analyte may be pumped through conduits and a column comprising a material which is capable of separating different components of the fluidic analyte. Such a material, so-called beads which may comprise silica gel, may be filled into a column tube which may be connected to other elements (like a control unit, containers including sample and/or buffers) by conduits.

When a fluidic sample is pumped through the column tube, it is separated into different fractions. The separated fluid may be pumped in a flow cell in which the different components are identified on the basis of an optical detection mechanism.

U.S. Pat. No. 7,435,982 discloses an apparatus for producing light which includes a chamber and an ignition source that ionizes a gas within the chamber. The apparatus also includes at least one laser that provides energy to the ionized gas within the chamber to produce a high brightness light. The laser can provide a substantially continuous amount of energy to the ionized gas to generate a substantially continuous high brightness light.

U.S. Pat. No. 4,241,382 discloses a fiber optics illuminator consisting of a light bulb having a fiber optics coupler or coupling means integral with the bulb envelope. The bulb is provided with a combination of ellipsoidal and spherical mirrors which together direct all light emitted from the filament through a small optical window located at the rear of said coupler or coupling means. To facilitate trapping of the light in the optical fibers, the light is made to emerge from the optical window at angles equal to or less than the critical angle of the fibers.

U.S. Pat. No. 4,755,918 discloses a reflector system comprising a reflector having an ellipsoidal portion and a hemispherical portion joined together at an intersection of a plane passing through a focus of said ellipsoidal portion normal to a major axis of said ellipsoidal portion, a hemisphere center of said hemispherical portion coinciding with said focus, a light source generally positioned at said focus, said ellipsoidal portion terminating in an opening forwardly of said focus covered by a mirror extending normal to the major axis of said ellipsoidal portion for redirecting light rays emitted from said light source back through said reflector, and said hemispherical portion terminating in another opening spaced rearwardly from said focus through which the light rays are redirected by said mirror to a final focus located exteriorly of said reflector.

U.S. Pat. No. 5,927,849 discloses a compact coupling arrangement between a light source and a plurality of light distribution harnesses which includes a plurality of reflector members arranged around the light source with respective focal points of the reflector members positioned substantially coincident with the light source, so as to receive light from the source and reflect the light away from the source. Further included is a plurality of light coupling members, each having an inlet and an outlet surface for receiving light originating from the light source and transmitting light, respectively. A plurality of light distribution harnesses is provided for respectively receiving light from the light coupling members. The light coupling members each comprise a lens having a negative curvature in at least one direction generally transverse to a main light transmission axis there through, for receiving light at a first angular distribution and transmitting light at a reduced angular distribution. To facilitate manufacturing, at least one of the light coupling members may comprise an integral portion of one of the reflector members coinciding with the curvature of a proximate reflector member. Further, at least one of the inlet and outlet surfaces of one of the coupling members may be non-axisymmetrical about the main light transmission axis of its associated coupling member, for improving efficiency of light coupling.

U.S. Pat. No. 6,976,384 discloses high throughput liquid chromatography systems which include multiple separation columns and multiple flow-through detection regions in sensory communication with a common radiation source and a multi-channel detector. Preferred detector types include a multi-anode photomultiplier tube, a charge-coupled device detector, a diode array, and a photodiode array. Separation columns may be microfluidic and integrated into a unitary microfluidic device. The optical path through a detection region is preferably coaxial with the path of eluate flow along a flow axis through a detection region.

Conventional detection cells may suffer from a limited efficiency.

### BRIEF SUMMARY

It is an object of the invention to enable sample detection using a flow cell with a sufficiently high detection accuracy. The object is solved by the independent claims. Further embodiments are shown by the dependent claims.

According to an exemplary embodiment of the present invention, a sample detection apparatus for detecting a fluidic sample in a flow cell of a sample separation system is provided, the sample detection apparatus comprising an electromagnetic radiation source having a chamber configured for generating a plasma, and an energy source configured for generating and directing an energy beam towards the plasma for heating the plasma so that the plasma emits primary electromagnetic radiation, and a detection path being arranged in (or being aligned along) a detection direction, wherein the detection direction is arranged angularly displaced (or is tilted) with respect to a propagation direction of the energy beam, so that primary electromagnetic radiation propagating in the detection direction enters the detection path, wherein the detection path comprises an electromagnetic radiation detector configured for detecting secondary electromagnetic radiation being characteristic for the fluidic sample and resulting from an interaction between the fluidic sample and the primary electromagnetic radiation propagating in the detection direction or at least a portion thereof.

According to another exemplary embodiment, a sample detection apparatus for detecting a plurality of fluidic samples in flow cells of a sample separation system is provided, the sample detection apparatus comprising an electromagnetic radiation source configured to emit primary electromagnetic radiation, wherein the electromagnetic radiation source has a chamber configured for generating a plasma, and an energy source configured for generating and directing an energy beam towards the plasma for heating the plasma so that the plasma emits the primary electromagnetic radiation, and a plurality of detection paths each being arranged so that a respective part of the primary electromagnetic radiation enters a respective one of the detection paths, wherein each of the detection paths comprises an electromagnetic radiation detector configured for detecting secondary electromagnetic radiation being characteristic for the respective one of the plurality of fluidic samples and resulting from an interaction between the respective fluidic sample and the respective part of the primary electromagnetic radiation.

According to still another exemplary embodiment, a sample separation system for separating components of a fluidic sample is provided, the sample separation system comprising a separation unit configured for separating the fluidic sample into the components (or a plurality of separation units each configured for separating a respective one of a plurality of fluidic samples into components), a flow cell in fluid communication with the separation unit for receiving the separated sample fluid from the separation unit (or a plurality of flow cells each in fluid communication with a respective one of the plurality of separation units and each for receiving a respective one of the separated sample fluids from the respective separation unit), and a sample detection apparatus having the above-mentioned features and being configured for detecting the separated components.

According to yet another exemplary embodiment, a method of detecting a fluidic sample in a flow cell of a sample separation system is provided, the method comprising generating a plasma in a chamber, generating and directing an energy beam towards the plasma for heating the plasma so that the plasma emits primary electromagnetic radiation, arranging a detection path in a detection direction, wherein the detection direction is arranged angularly displaced with respect to a propagation direction of the energy beam, so that primary electromagnetic radiation propagating in the detection direction enters the detection path, and detecting, in the detection path, secondary electromagnetic radiation being characteristic for the fluidic sample and resulting from an interaction between the fluidic sample and the primary electromagnetic radiation propagating in the detection direction or at least a portion thereof.

According to still another exemplary embodiment, a method of detecting a plurality of fluidic samples in flow cells of a sample separation system is provided, the method comprising emitting primary electromagnetic radiation using an electromagnetic radiation source which has a chamber configured for generating a plasma, and an energy source configured for generating and directing an energy beam towards the plasma for heating the plasma so that the plasma emits the primary electromagnetic radiation, arranging each of a plurality of detection paths so that a respective part of the primary electromagnetic radiation enters a respective one of each of the detection paths, and detecting, in each of the detection paths, secondary electromagnetic radiation being characteristic for the respective one of the plurality of fluidic samples and resulting from an interaction between the respective fluidic sample and the respective part of the primary electromagnetic radiation.

The term “electromagnetic radiation” may particularly denote an ensemble of photons. The electromagnetic radiation may be, for instance, in the range of visible light, ultraviolet radiation, or infrared radiation.

The term “flow cell” may particularly denote a fluidic channel through which a fluidic sample, which may already be separated, can flow. In the flow cell, electromagnetic radiation may be introduced, and subsequently the fluidic sample may be characterized by detecting the absorption of the electromagnetic radiation by the fluidic sample, or by detecting fluorescence radiation emitted by the fluidic sample upon being excited with primary electromagnetic radiation.

The term “plasma” may particularly denote an ionized gas composed of ions, electrons and neutral particles. It is a phase of matter distinct from solids, gas and liquid. In other words, a plasma may be denoted as a gas in which a certain proportion of its particles is ionized.

The term “energy source” may particularly denote any source which may provide energy in any form for generating a corresponding energy beam. Particularly, such an energy beam may be an intense beam of electromagnetic radiation such as light, but may also be in the form of heat, electric power, etc.

The term “detection path” may particularly denote an arrangement of one or more components in which electromagnetic radiation originating from an electromagnetic radiation source is directed towards a separated fluidic sample so as to sense the response of the fluidic sample on this electromagnetic radiation.

The term “propagation direction” may particularly denote a direction along which the primary energy beam (or a center thereof) such as a laser beam propagates after emission by the energy source. The term “propagation direction” may also denote a direction along which the primary energy beam (or a center thereof) such as a laser beam propagates through the chamber towards the plasma. The center of such a beam may be defined as the center of gravity of the beam, i.e. an averaging over a beam profile.

The term “detection direction” may particularly denote a direction along which a detection path is aligned to allow the introduction of electromagnetic radiation propagating along a corresponding direction to bring this electromagnetic radiation in interaction with the fluidic sample.

According to a first exemplary aspect, a sample detection system is provided in which a detection direction along which a detection path is supplyable with primary electromagnetic radiation is arranged tilted with regard to an energy beam directed onto a plasma for generating the primary electromagnetic radiation. By taking this measure, it may be safely prevented that the energy beam disturbs the detection within the detection path, since the angular displacement of the detection direction with regard to the propagation direction ensures that the energy beam is prevented from entering the detection path.

According to a second exemplary aspect, a sample detection system is provided in which one electromagnetic radiation source serves a plurality of detection paths simultaneously by providing them with electromagnetic radiation as a basis for a corresponding detection procedure. Therefore, multiple detection paths may be operated in conjunction with a single electromagnetic radiation source, thereby rendering the use of the generated primary electromagnetic radiation very efficient. By using a point light source formed by a plasma heated by an energy beam as electromagnetic radiation source, a long lifetime and a constant and stable radiation characteristic may be ensured while at the same time benefiting from a high efficiency of energy conversion.

In the following, further exemplary embodiments of the sample detection apparatuses according to both expects will be explained. However, these embodiments also apply to the sample separation system and to the methods. It should further be appreciated that all disclosure of this description, the figures and the claims which is mentioned for one of the aspects also applies to the respective other aspect.

In an embodiment, the chamber may comprise an ignition source for generating the plasma. Such an ignition source can be or can include electrodes, an ultraviolet ignition source, a capacitive ignition source, an inductive ignition source, a high frequency ignition source, a microwave ignition source, a flash lamp, a pulse laser, or a pulse lamp. By such an ignition, the plasma may be generated in the chamber as a basis for the subsequent interaction with the energy beam.

In an embodiment, energy source may comprise a laser. The laser may direct a beam to the plasma so that, due to an interaction between the laser beam and the plasma, a very intense electromagnetic radiation is generated. Since a laser beam is highly parallel and coherent, a very narrow beam can be emitted so that, due to the inclined arrangement of the one or more detection paths, the primary laser beam can be safely prevented from unintentionally interacting with the detection path or paths.

As an alternative to the provision of a laser as the energy source for heating the plasma so that the plasma emits primary electromagnetic radiation, it is also possible to use for instance a deuterium lamp, a xenon lamp, a tungsten lamp or the like. As energy source, the electromagnetic radiation source may also comprise an arc lamp having electrodes spaced apart from one another and being configured to emit light upon applying a power signal to the electrodes.

The electromagnetic radiation source may further comprise one or more waveguides configured for guiding the energy beam from the energy source into the chamber. Particularly in case that the energy beam is an electromagnetic radiation beam of any desired wavelength (for instance visual light, ultraviolet light, infrared light, etc.), the use of a waveguide, particularly an optical fiber, may allow to introduce basically the entire electromagnetic radiation into the chamber, thereby resulting in a very efficient generation of electromagnetic radiation.

In an embodiment, the electromagnetic radiation source may comprise a focusing optics configured for focusing the energy beam towards a predefined position within the chamber. Such a focusing optics may comprise one or more lenses. The focusing optics may be shaped and dimensioned so that the energy beam is focused to a very small volume, resulting in a point light source emitting light into many directions at the same time. Such a point light source is a proper basis for a multi-channel detection arrangement in which multiple flow cells can be used simultaneously for detecting different samples.

In an embodiment, the electromagnetic radiation source may be configured for generating the plasma within a spatially limited region in the chamber. The limited region may have a diameter of less than about 500 μm. In another embodiment, the limited region may have a diameter of less than about 300 μm, more particularly of less than about 150 μm. In such embodiments, the dimension of the limited region may be larger than 1 μm, particularly larger than 10 μm. With such a point light source, it is possible to obtain a basically isotropic electromagnetic radiation, allowing for a selection of any desired detection direction or of a multiple channel detection arrangement.

The detection path (or each of multiple detection paths) may be arranged outside of (or apart from) an angular range of about ±10°, particularly of about ±20°, more particularly of about ±30°, around the propagation direction of the energy beam (compare for instance FIG. 3). If the one or more detection paths is or are arranged outside of or apart from these angular ranges, undesired cross-talk between the generated electromagnetic radiation and the primary energy beam may be safely prevented in the detection path, thereby allowing to obtain an accurate and reliable detection result.

The fluidic sample may be spatially located between the primary electromagnetic radiation beam and the electromagnetic radiation detector to thereby detect absorption of a part of the primary electromagnetic radiation by the fluidic sample by a component of the fluidic sample to be detected. Hence, one embodiment may detect the presence of fractions of the fluidic sample by an absorption measurement based on analyzing dips in the transmission spectrum or peaks in an absorption spectrum. For performing an absorption measurement, it may be advantageous to provide a monochromator upstream the flow cell for generating monochromatic light from the electromagnetic radiation before directing the beam onto the fluidic sample. This may increase the accuracy of the measurement.

Alternatively, the electromagnetic radiation detector may be located to detect fluorescence radiation emitted by the fluidic sample upon interaction with the primary electromagnetic radiation. In such an embodiment, a part of the primary electromagnetic radiation is absorbed by specific fractions of the fluidic sample causing re-emission of electromagnetic radiation at another wavelength (fluorescence). In order to avoid cross-talk between primary electromagnetic radiation and fluorescence radiation, the detection of fluorescence may be performed at an angle, for instance at a right angle, with regard to the primary electromagnetic radiation beam. In other words, a direction along which the electromagnetic radiation impinges on the detection path may differ from the direction along which the actual detector is aligned for detecting the fluorescence radiation from the fluidic sample.

The electromagnetic radiation detector may be located to detect fluorescence radiation emitted by the fluidic sample upon interaction with the primary electromagnetic radiation. In order to promote such a fluorescence effect, it may be possible to label components of the fluidic sample with fluorescence labels having known fluorescence characteristics.

According to an embodiment, the detection path may comprise the flow cell accommodating the fluidic sample and being arranged in an optical path between the primary electromagnetic radiation and the electromagnetic radiation detector. The flow cell may comprise a transparent (for the primary electromagnetic radiation) capillary or any other appropriate fluidic path through which the fluidic sample may flow. Thus, during flowing through the flow cell, the electromagnetic radiation may interact with the fluidic sample so that absorption or fluorescence characteristic of the fluidic sample may be measured.

According to an embodiment, the detection path may comprise a primary electromagnetic radiation monochromator in an optical path upstream of the fluidic sample. The monochromator may generate monochromatic electromagnetic radiation, i.e. electromagnetic radiation of basically one wavelength. The skilled person will understand that there will always be a certain line width of radiation, but this may be very small for electromagnetic radiation downstream the monochromator (for instance Δλ/λ<5%, particularly Δλ/λ<0.1%, more particularly Δλ/λ<0.1%). Since the described electromagnetic radiation source using a plasma which is heated up by the energy beam to thereby irradiate the electromagnetic radiation of different wavelengths into different directions, it may be advantageous to filter out other wavelength components which are not desired for a specific application (for instance a fluorescence measurement). This may be performed by a monochromator which may be realized by a grating assembly, a wavelength selective filter, etc.

Additionally or alternatively, the detection path may comprise a secondary electromagnetic radiation monochromator in an optical path downstream of the fluidic sample and upstream of the electromagnetic radiation detector. The monochromator may generate monochromatic electromagnetic radiation, i.e. electromagnetic radiation of basically one wavelength. The skilled person will understand that there will always be a certain line width of radiation, but this may be very small for electromagnetic radiation downstream the monochromator (for instance Δλ/λ<5%, particularly Δλ/λ<1%, more particularly Δλ/λ<0.1%). The secondary electromagnetic radiation monochromator may be realized as a grating assembly, a wavelength selective filter, or the like. The secondary electromagnetic radiation monochromator may select a desired wavelength of the secondary electromagnetic radiation so as to supply this specific wavelength to the actual electromagnetic radiation detector.

In an embodiment, the sample detection apparatus may be configured for detecting a plurality of fluidic samples in flow cells of the sample separation system simultaneously. This may be denoted as a multiple channel detection apparatus. In such an embodiment, the sample detection apparatus may further comprise at least one further detection path being angularly arranged with respect to the propagation direction of the energy beam so that primary electromagnetic radiation propagating in a direction differing from the propagation direction of the energy beam enters the at least one further detection path. In other words, at least one further detection path may be arranged along at least one further detection direction, wherein the at least one detection direction may be arranged angularly displaced with respect to the propagation direction of the energy beam (and angularly displaced with respect to the other detection direction), so that primary electromagnetic radiation propagating in the at least one further detection direction enters the respective further detection path. The at least one further detection path may comprise at least one further electromagnetic radiation detector configured for detecting further secondary electromagnetic radiation being characteristic for the respective one of the plurality of fluidic samples and resulting from an interaction between the respective fluidic sample and the primary electromagnetic radiation.

For example, 2, 3, 4, 5, 6, 7, 8, 9, 10 or more detection paths may be arranged around (for instance radially around) a point light source emitting electromagnetic radiation into multiple directions and therefore serving as a source for all of the detection paths at the same time. This may allow, in a very compact design, the simultaneous detection of multiple fluidic samples.

Particularly the above described electromagnetic radiation source with plasma chamber and heating energy beam is particularly appropriate for such a radially distributed arrangement of multiple detection paths, since such an electromagnetic radiation source has point source like properties and emits electromagnetic radiation over a large angular range. For instance, the detection paths may be arranged symmetrically on a virtual spherical surface around the heated plasma as a center, thereby efficiently using the emitted electromagnetic radiation. It is also possible that the detection paths are arranged symmetrically along a virtual circular line around the heated plasma as a center, thereby efficiently using the emitted electromagnetic radiation.

The detection path and the at least one further detection path may be located at different angular positions around the plasma so as to be supplied simultaneously with different parts of the primary electromagnetic radiation. The actual arrangement of the detection paths around the point light source may be configured in accordance with the spatial irradiation characteristics of the point light source. However, it may be appropriate to arrange the various detection paths with a constant angular and/or radial distance from one another around the point light source. The detection sensitive directions along which the detection paths are aligned may be inclined relative to one another and may be angularly displaced with regard to the energy beam. By taking this measure, a high detection accuracy in each of the detection paths may be ensured.

In an embodiment, the detection path may be angularly arranged with respect to the propagation direction of the energy beam in such a manner that the detection path is shielded from the energy beam. In other words, the one or more detection paths may be arranged in a shadow of the energy beam which could deteriorate the detection performance in the individual channels.

The detection path may be angularly arranged with respect to the propagation direction of the energy beam so that exclusively primary electromagnetic radiation propagating in the direction differing from the propagation direction of the energy beam enters the detection path. In other words, other sources of electromagnetic radiation may be disabled from providing electromagnetic radiation in a relevant range of detection wavelength to the detection paths.

It may be advantageous that the electromagnetic radiation source is configured as a point light source to simultaneously emit the primary electromagnetic radiation into multiple directions, wherein each of the plurality of detection paths may be located so that a part of the primary electromagnetic radiation from one of the multiple directions enters the respective detection path. Such a point light source may function in a similar way as a miniature sun. A point light source may emit electromagnetic radiation basically isotropically in all directions with a basically constant intensity depending only from the distance. This may be a proper basis for a multi-channel architecture with properly comparable detection performance and hence a good reproducibility, since the different channels may then be supplied with very similar exciting electromagnetic radiation.

The electromagnetic radiation source may be configured for generating one of an optical light beam (or a visible light beam) and an ultraviolet beam. Optical light may cover a wavelength region between about 400 nm and about 800 nm. Ultraviolet beams have a shorter wavelength than optical light. Correspondingly, the electromagnetic radiation detector may comprise an optical light detector or an ultraviolet radiation detector.

The electromagnetic radiation detector may comprise a single detection element (such as a photodiode), a linear array of detection elements or a two-dimensional array of detection elements (for instance arranged in a matrix-like manner). Hence, the electromagnetic radiation detector may be a zero-dimensional, one-dimensional or two-dimensional array of photodetectors. It is also possible that a photomultiplier is used as an electromagnetic radiation detector.

The above described electromagnetic radiation source having a plasma generation chamber in combination with an energy source for heating the plasma can be considered as an alternative to a conventional deuterium lamp. Such an electromagnetic radiation source is smaller and provides for an isotropic irradiation of electromagnetic radiation, thereby functioning as a point light source. Using such an electromagnetic radiation source provides for a simple and compact architecture and allows to serve multiple detection paths simultaneously. Furthermore, such an electromagnetic radiation source is sufficiently stable for HPLC applications, since this requires very small signal changes to be detected. Such an electromagnetic radiation source, particularly using a laser for generating the energy beam, may allow for an electrode-less configuration, since a plasma may be ignited by the focusing of a light beam. This provides for a broadband light source with a sufficiently high stability and a high brightness. In contrast to a deuterium lamp being a volumetric irradiator, the irradiation characteristic of such an electromagnetic radiation source is properly suitable for flow cells of sample separation apparatuses.

An embodiment of the invention makes it possible to measure multiple samples at the same time or in parallel in different detection paths with a single electromagnetic radiation source. More generally, a number of electromagnetic radiation sources implemented for such a parallel detection architecture may be smaller than a number of detection channels.

In the following, further exemplary embodiments of the sample separation system will be explained. However, these embodiments also apply to the sample detection apparatuses and the methods.

The sample separation system may comprise a separation element filled with a separating material. It is also possible that such a separation element filled with a separating material may be provided for each detection path separately. Such a separating material which may also be denoted as a stationary phase may be any material which allows an adjustable degree of interaction with a fluidic sample so as to be capable of separating different components of such a fluidic sample. The separation element may be arranged in a fluidic path upstream the detector so that fractions of a sample separated by the separation element may be subsequently detected by the detector device.

The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc) surface. However, any packing material can be used which has material properties allowing an analyte passing through this material to be separated into different components, for instance due to different kinds of interactions or affinities between the packing material and fractions of the analyte.

At least a part of the separation element may be filled with a fluid separating material, wherein the fluid separating material may comprise beads having a size in the range of essentially 1 μm to essentially 50 μm. Thus, these beads may be small particles which may be filled inside the separation section of the microsample separation system. The beads may have pores having a size in the range of essentially 0.01 μm to essentially 0.2 μm. The fluidic sample may be passed through the pores, wherein an interaction may occur between the fluidic sample and the pores.

The sample separation system may be configured as a fluid separation system for separating components of the sample. When a mobile phase including a fluidic sample passes through the sample separation system, for instance with a high pressure, the interaction between a filling of the column and the fluidic sample may allow for separating different components of the sample, as performed in a liquid chromatography device.

However, the sample separation system may also be configured as a fluid purification system for purifying the fluidic sample. By spatially separating different fractions of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the column. Due to the different interaction of the different protein fractions with the filling of the column (for instance using a liquid chromatography device), the different samples may be distinguished, and one sample or band of material may be selectively isolated as a purified sample. The detector may then serve for controlling the success of the purification.

The sample separation system may be configured to analyze at least one physical, chemical and/or biological parameter of at least one component of the mobile phase. The term “physical parameter” may particularly denote a size or a temperature of the fluidic sample. The term “chemical parameter” may particularly denote a concentration of a fraction of the fluidic sample, an affinity parameter, or the like. The term “biological parameter” may particularly denote a concentration of a protein, a gene or the like in a biochemical solution, a biological activity of a component, etc.

The sample separation system may be implemented in different technical environments, like a sensor device, a test device, a device for chemical, biological and/or pharmaceutical analysis, or a liquid chromatography device. Particularly, the sample separation system may be a liquid chromatography device such as a High Performance Liquid device (HPLC) device by which different fractions of an analyte may be separated, examined and analyzed. Also applications in the field of electrophoresis are possible.

The sample separation system may be configured to conduct the mobile phase through the system with a high pressure, for instance of 50 bar to 100 bar, particularly of at least 600 bar, more particularly of at least 1200 bar.

The sample separation system may be configured as a microsample separation system. The term “microsample separation system” may particularly denote a sample separation system as described herein which allows to convey fluid through microchannels having a dimension in the order of magnitude of less than 500 μm, particularly less than 200 μm, more particularly less than 100 μm or less than 50 μm or less.

Exemplary embodiments might be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

The separating device preferably comprises a chromatographic column (see for example http://en.wikipedia.org/wiki/Column chromatography) providing the stationary phase. The column might be a glass or steel tube (for example with a diameter from 50 μm to 5 mm and a length of 1 cm to 1 m) or a microfluidic column (as disclosed for example in EP 1577012 or the Agilent 1200 Series HPLC-Chip/MS System provided by the applicant Agilent Technologies, see for example http://www.chem.agilent.com/Scripts/PDS.asp?IPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen for example to minimize the retention of the compounds of interest and/or the amount of mobile phase to run the chromatography. The mobile phase can also been chosen so that the different compounds can be separated effectively. The mobile phase might comprise an organic solvent like for example methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The fluidic sample might comprise any type of process liquid, natural sample like juice, body fluids like plasma or it may be the result of a reaction like from a fermentation broth.

The HPLC system might comprise a sampling unit for introducing the fluidic sample into the mobile phase stream, a detector for detecting separated compounds of the fluidic sample, a fractionating unit for outputting separated compounds of the fluidic sample, or any combination thereof.

According to an embodiment, parallel detection using a point light source may be made possible. More specifically, parallel spectrophotometric HPLC detection using a point light source may be made possible.

A laser-driven light source may be used which may be based on a chamber having a plasma therein, wherein the plasma is heated to irradiate a spectrum of electromagnetic radiation. This heating may be promoted by a laser source emitting laser radiation which is coupled into the chamber. Specifically for the application in the field of HPLC, it may be advantageous that such a light source may provide a very high brightness across a wide spectrum (strong in UV and visual range). Such an electromagnetic radiation source may have a very long lifetime and may serve as a permanent detector lamp. It may generate a very small spot size which supports the tendency of miniaturization in HPLC.

Such a point light source (miniature sun) radiating basically in all spatial directions is considered as an ideal solution for parallel HPLC (UV) detection using a single light source. In case of too high intensity fluctuations of the light source, the various detection channels may be used in addition as reference channels to compensate for effects resulting from such fluctuations.

Hence, parallel detection using such a laser-driven plasma as a single light source may be made possible. Because of the unique features of such a light source (basically the same light output in all spatial directions), it is possible to arrange multiple, basically equivalent channels to perform parallel optical detection (for instance forming a star-like arrangement with the electromagnetic radiation source being the center of the star). Each channel may comprise optics, the detector flow cell and a photodetector to convert the photons into a usable electrical signal. Such a configuration may be beneficial from the point of view of manufacturing costs and costs of maintenance. It may even allow for the compensation of lamp instabilities by using the various channels as reference channels in the absence of chromatographic peaks.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a sample separation system in accordance with embodiments of the present invention, for example used in high performance liquid chromatography (HPLC).

FIG. 2 to FIG. 8 show sample detection apparatuses or parts thereof in accordance with embodiments of the present invention, for example used in high performance liquid chromatography (HPLC).

The illustration in the drawing is schematically.

### DETAILED DESCRIPTION

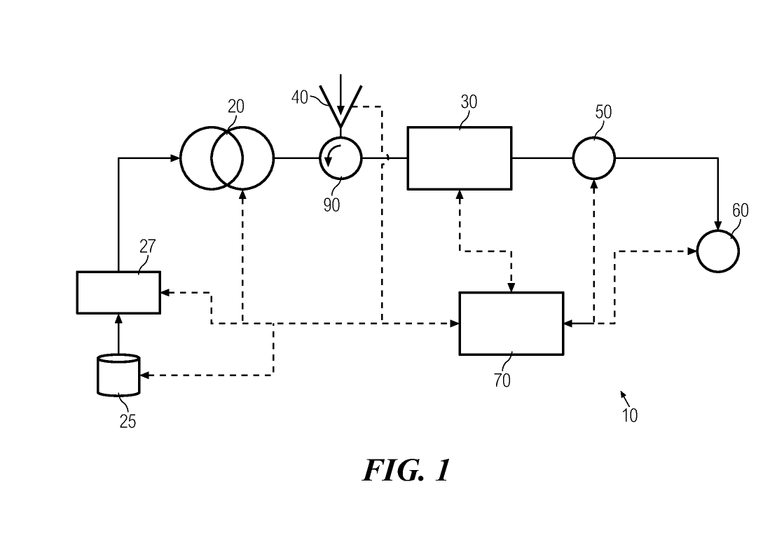

Referring now in greater detail to the drawings, FIG. 1 depicts a general schematic of a liquid separation system 10 as a sample separation system in accordance with an embodiment of the present invention. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a fluidic sample into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

The detector 50 is illustrated in FIG. 1 in a schematic way only. However, the below described figures will provide details as to how such a detector can be configured according to exemplary embodiments. The described detector 50 may allow for the detection of one fluidic sample only, whereas other embodiments allow to share a light source of such a detector 50 among multiple separate liquid separation systems 10 as a common light source.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the components in the liquid separation system 10 in order to receive information and/or control operation. For example, the data processing unit 70 might control operation of the pump 20 (for example setting control parameters) and receive therefrom information regarding the actual working conditions (such as output pressure, flow rate, etc. at an outlet of the pump). The data processing unit 70 might also control operation of the solvent supply 25 (for example setting the solvent/s or solvent mixture to be supplied) and/or the degasser 27 (for example setting control parameters such as vacuum level) and might receive therefrom information regarding the actual working conditions (such as solvent composition supplied over time, flow rate, vacuum level, etc.). The data processing unit 70 might further control operation of the sampling unit 40 (for example controlling sample injection or synchronization sample injection with operating conditions of the pump 20). The separating device 30 might also be controlled by the data processing unit 70 (for example selecting a specific flow path or column, setting operation temperature, etc.), and send—in return—information (for example operating conditions) to the data processing unit 70. Accordingly, the detector 50 might be controlled by the data processing unit 70 (for example with respect to spectral or wavelength settings, setting time constants, start/stop data acquisition), and send information (for example about the detected sample compounds) to the data processing unit 70. The data processing unit 70 might also control operation of the fractionating unit 60 (for example in conjunction with data received from the detector 50) and provides data back.

Reference numeral 90 schematically illustrates a switchable valve which is controllable for selectively enabling or disabling specific fluidic paths within apparatus 10.

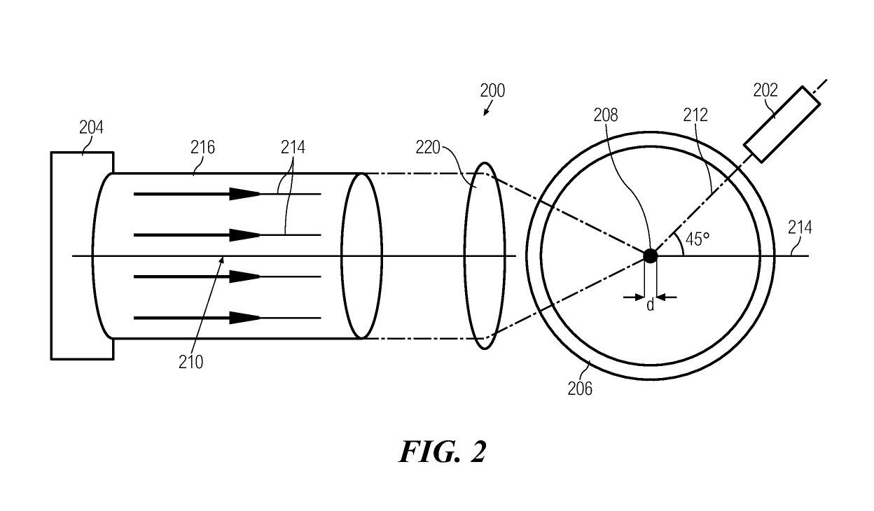

In the following, referring to FIG. 2, a sample detection apparatus 200 according to an exemplary embodiment will be described.

The sample detection apparatus 200 is adapted for detecting a fluidic sample in a flow cell of a sample separation system 10 such as the one shown in FIG. 1.

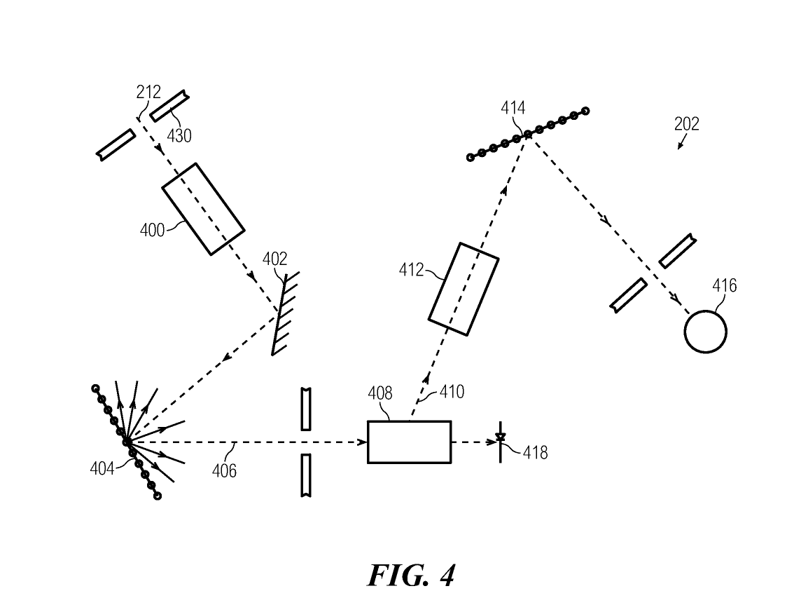

The flow cell is part of a detection path 202 which will be described below in more detail. The sample detection apparatus 200 basically equals to reference numeral 50 in FIG. 1. The detection path 202 may comprise optical elements and a flow cell including a detector, this will be described below in more detail (compare for instance FIG. 4).

The sample detection apparatus 200 comprises a laser 204 as an energy source and a chamber 206 such as a hollow spherical structure within which a plasma 208 may be generated. The plasma 208 may be generated by any appropriate ignition source such as a pair of spaced electrodes, microwaves, etc. The laser 204 serves as a light source for generating a light beam 210 which is directed into the chamber 206 to be focused towards a small central portion thereof in which the plasma 208 is already formed. Thus, the laser beam 210 focused onto the plasma 208 and therefore heats the plasma 208 to an appropriate temperature so that the plasma 208 emits primary electromagnetic radiation in various directions and at various wavelengths, according to Planck's law. This electromagnetic radiation is emitted isotropically to basically all directions.

Detection path 202 is aligned along a detection direction 212. Only primary electromagnetic radiation originating from the point light source formed by heated plasma 208 that is emitted in the detection direction 212 is capable of entering the detection path 202 to be used within the detection path 202 for detection purposes. In the embodiment of FIG. 2, the detection direction 212 is angularly tilted by about 45° relative to a propagation direction 214 of the laser light beam 210. The propagation direction 214 corresponds to a direction along which an intensity of the energy beam 210, after having passed the plasma 208, has a maximum. Due to the focusing optics 220, there will also be some remaining intensity of the energy beam 210, after having passed the plasma 208, at small angles such as less than ±10° around the propagation direction 214. The propagation direction 214 is therefore the direction along which the laser light beam 210 basically propagates after emission by the laser 204 as well as the direction along which the center of the laser light beam 210 propagates through the chamber 206 towards the plasma 208 and then away from the plasma 208.

The detection path 202 comprises, although not shown in FIG. 2, an electromagnetic radiation detector configured for detecting secondary electromagnetic radiation being characteristic for the fluidic sample and resulting from an interaction between the fluidic sample and the primary electromagnetic radiation propagating in the detection direction 214, or at least a portion thereof.

Furthermore, the electromagnetic radiation source comprises an optical fiber 216 serving as a waveguide for guiding the laser light beam 210 from the laser 204 into the chamber 206. Furthermore, a focusing lens 220 is provided to serve as a focusing optics configured for focusing the laser light beam 210 towards a predefined position within the chamber 206, in the present case towards a center of the spherical chamber 206. The dimension of the plasma 208 which is heated by the laser beam 210 is denoted as “d” in FIG. 2, wherein d may be in the order of magnitude of 100 rim. Since the detection path 202 is arranged in an alignment or building line of the detection direction 212, it can be ensured that basically all electromagnetic radiation entering the detection path 202 originates from the point light source, i.e. the heated plasma 208, and basically no light from the laser beam 210 directly enters the detection path 202. If desired or required, it is possible to implement mirror optics in the optical arrangement shown in FIG. 2.

Thus, the laser light from the laser 204 is guided through the optical fiber 216 and focused by the lens 220 into an interior of the chamber 206 containing gas and the plasma 208. For instance, the laser light 210 has a wavelength of 980 nm. Light of this wavelength might disturb the detection of fluidic samples of a HPLC in the detection path 202. Without wishing to be bound to a specific theory, it is presently believed that the plasma 208 may absorb the laser light 210 and may convert it with a high degree of efficiency (for instance 90%) into primary light which is emitted into various direction with a very high intensity. The laser beam 210 of the laser source 204 may have an output power of 20 W and a wavelength of 980 nm. It can be focused by the focusing optics 220 to a volume with a diameter of few micrometers. The current for driving the laser (such as a laser diode) 204 as well as the configuration of the focusing optics 220 determine the wavelength distribution of the electromagnetic radiation emitted from the point light source constituted by the heated plasma 208.

It is possible to omit electrodes for ignition of the plasma 208 within the chamber 206, for instance by using a microwave excitation or the like. Hence, the lifetime of the light source shown in FIG. 2 is very high, since no deterioration of electrodes occurs during the use.

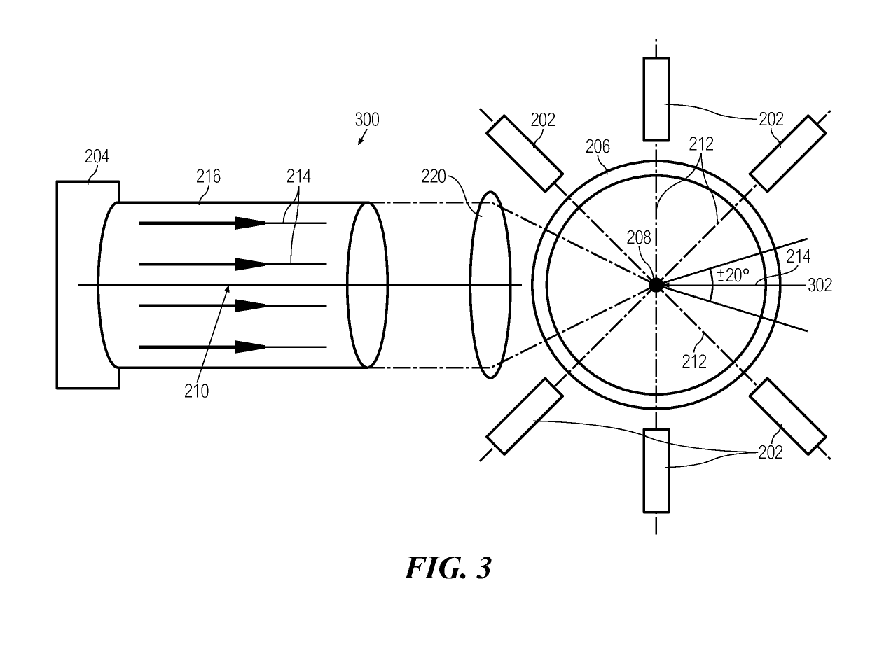

In a sample detection apparatus 300 shown in FIG. 3 according to another embodiment, six parallel, independently operable detection channels 202 are arranged angularly distributed around the chamber 206 so that the chamber 206 with the heated plasma 208 therein in combination with the laser 204 serves as a single electromagnetic radiation source supplying six detection paths simultaneously with electromagnetic radiation.

In other words, one single point light source 302 serves as a common light source for six parallel detection channels. None of the detection channels 202 is arranged within an angle of ±20° around the propagation direction 214 of the primary light beam 210. Moreover, each of the detection channels 202 is arranged so as to not interact with the heating laser light beam 210 before impinging on the plasma 208.

In the following, referring to FIG. 4, an interior construction of a detection channel 202, as illustrated schematically in FIG. 2 and FIG. 3, will be described in a fluorescence arrangement.

Light from the heated plasma 208 as shown in FIG. 2 or FIG. 3 propagating along the detection direction 212 passes an aperture 430 and enters a condenser 400. The electromagnetic radiation is then reflected by a mirror 402 and is directed to a grating assembly 404 serving as a monochromator. Hence, light of one selectable wavelength (or with a narrow line width) is directed along a direction 406 to a flow cell 408 through which the chromatographically separated fluidic sample flows. Referring to FIG. 1, the flow cell 408 is arranged directly downstream the separation column 30. If the fluidic sample has a fluorescence property or has fluorescence labels attached thereto, excitation by the primary light impinging along direction 406 will result in a generation of fluorescence radiation directed towards a fluorescence direction 410 deviating from the primary direction 406. The fluorescence radiation 410 is then directed through a further condenser 412 towards a further grating assembly 414 for generating monochromatic light which then falls onto a photomultiplier 416 for detection purposes.

A part of the light transmitting the flow cell 408 may be directed to an optional reference diode 418 which may be used, for instance, for calibration purposes or the like.

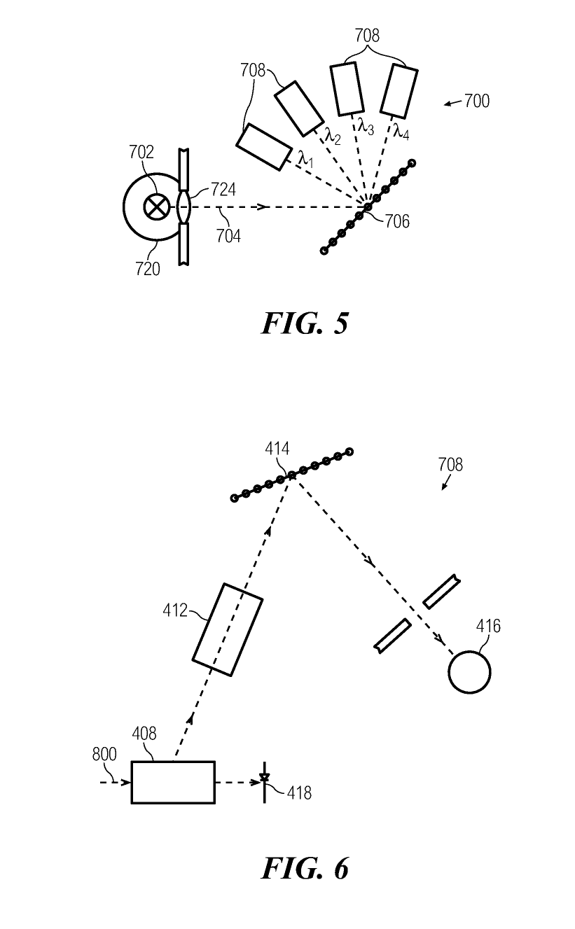

FIG. 5 shows a sample detection apparatus 700 according to another exemplary embodiment of the invention in which a light source 702 generates primary light 704.

The light source 702 can, for instance, be a light source as the one shown in FIG. 2 or FIG. 3. Alternatives are possible, for instance the laser 204 may be substituted by a deuterium lamp. In this case, a light collecting reflector 720 may be provided, if desired in combination with a focusing lens 724.

Primary electromagnetic radiation 704 generated by the light source 702 is directed to a grating assembly 706 which generates different beams of different monochromatic wavelengths denoted as λ1, λ2, λ3 and λ4. The monochromatic light of the different wavelengths can then be directed to a corresponding one of detection paths 708 which are operated at different wavelengths.

FIG. 6 shows an example of the internal constitution of the detection paths 708 (shown as black box in FIG. 5) according to an exemplary embodiment.

The light originating from the grating assembly 706 is denoted schematically with reference numeral 800 in FIG. 6 and is directed to a flow cell 408. Apart from the fact that, in contrast to FIG. 4, no grating assembly 404 upstream the flow cell 408 is required within the detection paths 708 due to the provision of the common grating assembly 706, the internal constitution of the detection path 708 is similar to the internal constitution of the detection path 202 shown in FIG. 4.

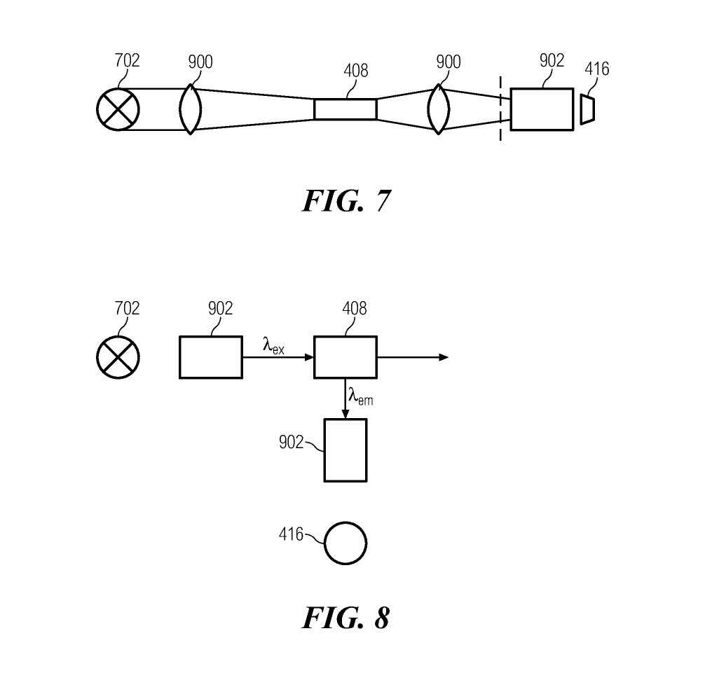

FIG. 7 schematically illustrates the constitution of an optical path for an absorption measurement, i.e. a measurement in transmission. A light source 702 may be operated in conjunction with the focusing optics 900, wherein a flow cell 408 is arranged between different lenses of the focusing optics 900. After having passed a monochromator 902 such as a grating assembly, the transmitted light can be detected by a detector 416.

In contrast to FIG. 7, FIG. 8 shows a detection architecture in fluorescence configuration. The light source 702 emits the light to a monochromator 902 such as a grating assembly so that an excitation wavelength λₑₓ is selected and is directed through a flow cell 408. By fluorescence, a fluorescence emission wavelength λₑₘ is generated which can be sent through another monochromator 902 and from there to a detector 416.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A sample detection apparatus for detecting a fluidic sample in a flow cell of a sample separation system, the sample detection apparatus comprising
an electromagnetic radiation source having a chamber configured for generating a plasma, and an energy source configured for generating and directing an energy beam towards the plasma for heating the plasma so that the plasma emits primary electromagnetic radiation;
a detection path being arranged in a detection direction, wherein the detection direction is arranged angularly displaced with respect to a propagation direction of the energy beam, so that primary electromagnetic radiation propagating in the detection direction enters the detection path;
wherein the detection path comprises an electromagnetic radiation detector configured for detecting secondary electromagnetic radiation being characteristic for the fluidic sample and resulting from an interaction between the fluidic sample and the primary electromagnetic radiation propagating in the detection direction or at least a portion thereof.

2. The sample detection apparatus according to claim 1,
wherein the chamber comprises an ignition source for generating the plasma, particularly comprises an ignition source for generating the plasma by ionizing gas in the chamber.

3. The sample detection apparatus according to claim 2,
wherein the ignition source comprises at least one of the group consisting of electrodes spaced apart and being supplyable with electric power, a radio frequency ignition source, and a microwave ignition source.

4. The sample detection apparatus according to claim 1,
wherein the energy source comprises a laser.

5. The sample detection apparatus according to claim 1,
wherein the electromagnetic radiation source comprises a waveguide, particularly an optical fiber, configured for guiding the energy beam from the energy source into the chamber.

6. The sample detection apparatus according to claim 1,
wherein the electromagnetic radiation source comprises a focusing optics configured for focusing the energy beam towards a predefined position within the chamber.

7. The sample detection apparatus according to claim 1,
wherein the electromagnetic radiation source is configured for generating the plasma within a limited region in the chamber, the limited region having a diameter of less than 500 μm, particularly of less than 300 μm, more particularly of less than 150 μm.

8. The sample detection apparatus according to claim 1,
wherein the detection path is arranged outside of an angular range of ±10°, particularly of ±20°, more particularly of ±30°, around the propagation direction of the energy beam or around a center of the propagation direction of the energy beam.

9. The sample detection apparatus according to claim 1, configured for detecting a plurality of fluidic samples in flow cells of the sample separation system simultaneously, the sample detection apparatus further comprising
at least one further detection path being angularly arranged with respect to the propagation direction of the energy beam so that primary electromagnetic radiation propagating in a direction differing from the propagation direction of the energy beam enters the at least one further detection path;
wherein the at least one further detection path comprises at least one further electromagnetic radiation detector configured for detecting further secondary electromagnetic radiation being characteristic for the respective one of the plurality of fluidic samples and resulting from an interaction between the respective fluidic sample and the primary electromagnetic radiation.

10. The sample detection apparatus according to claim 9,
wherein the detection path and the at least one further detection path are located at different angular positions around the plasma so as to be supplied simultaneously with different parts of the primary electromagnetic radiation.

11. The sample detection apparatus according to claim 1, comprising at least one of the following features:
the detection path comprises a primary electromagnetic radiation monochromator in an optical path upstream of the fluidic sample;
the detection path comprises a secondary electromagnetic radiation monochromator in an optical path downstream of the fluidic sample and upstream of the electromagnetic radiation detector;
the fluidic sample is spatially located between the primary electromagnetic radiation and the electromagnetic radiation detector to thereby detect absorption of a part of the primary electromagnetic radiation by the fluidic sample;
the electromagnetic radiation detector is located to detect fluorescence radiation emitted by the fluidic sample upon interaction with the primary electromagnetic radiation;
the detection path comprises the flow cell accommodating the fluidic sample and being arranged in an optical path between the primary electromagnetic radiation and the electromagnetic radiation detector;
the detection path is angularly arranged with respect to the propagation direction of the energy beam in such a manner that the detection path is shielded from the energy beam;
the detection path is angularly arranged with respect to the propagation direction of the energy beam so that exclusively primary electromagnetic radiation propagating in the direction differing from the propagation direction of the energy beam enters the detection path.

12. A sample detection apparatus for detecting a plurality of fluidic samples in flow cells of a sample separation system, the sample detection apparatus comprising
an electromagnetic radiation source configured to emit primary electromagnetic radiation, wherein the electromagnetic radiation source has a chamber configured for generating a plasma, and an energy source configured for generating and directing an energy beam towards the plasma for heating the plasma so that the plasma emits the primary electromagnetic radiation;
a plurality of detection paths each being arranged so that a respective part of the primary electromagnetic radiation enters a respective one of the detection paths;
wherein each of the detection paths comprises an electromagnetic radiation detector configured for detecting secondary electromagnetic radiation being characteristic for the respective one of the plurality of fluidic samples and resulting from an interaction between the respective fluidic sample and the respective part of the primary electromagnetic radiation.

13. The sample detection apparatus according to claim 12,
wherein each of the plurality of detection paths is arranged in a corresponding detection direction, wherein each of the detection directions is arranged angularly displaced with respect to a propagation direction of the energy beam, so that primary electromagnetic radiation propagating in the respective detection direction enters the respective detection path.

14. The sample detection apparatus according to claim 13,
wherein at least a part, particularly each, of the plurality of detection paths is arranged outside of an angular range of ±10°, particularly of ±20°, more particularly of ±30°, around the propagation direction of the energy beam.

15. The sample detection apparatus according to claim 12,
wherein the electromagnetic radiation source is configured as a point light source to simultaneously emit the primary electromagnetic radiation into multiple directions, wherein each of the plurality of detection paths is located so that a part of the primary electromagnetic radiation from one of the multiple directions enters the respective detection path.

16. The sample detection apparatus according to claim 12, comprising at least one of the following features:
the electromagnetic radiation source is configured for generating one of an optical light beam and an ultraviolet beam;
the electromagnetic radiation detector comprises one of an optical light detector, and an ultraviolet radiation detector;
the electromagnetic radiation detector comprises one of a single detection element, a linear array of detection elements, and a two-dimensional array of detection elements;
the flow cell is configured to conduct the fluidic sample with a high pressure;
the flow cell is configured to conduct the fluidic sample with a pressure of at least 50 bar, particularly of at least 100 bar, more particularly of at least 500 bar, still more particularly of at least 1000 bar;
the flow cell is configured to conduct a liquid fluidic sample;
the flow cell is configured as a microfluidic flow cell;
the flow cell is configured as a nanofluidic flow cell.

17. A sample separation system for separating components of a fluidic sample, the sample separation system comprising
a separation unit configured for separating the fluidic sample into the components;
a flow cell in fluid communication with the separation unit for receiving the separated sample fluid from the separation unit;
a sample detection apparatus according to claim 12 configured for detecting the separated components.

18. The sample separation system according to claim 17, comprising at least one of the following features:
the sample separation system comprises a fluid drive, particularly a pumping system, configured to drive the fluidic sample through the sample separation system;
the separation unit comprises a chromatographic column;
the sample separation system comprises a sample injector configured to introduce the fluidic sample fluid into a mobile phase;
the sample separation system comprises a collection unit configured to collect separated compounds of the fluidic sample;
the sample separation system comprises a data processing unit configured to process data received from the sample separation system;
the sample separation system comprises a degassing apparatus for degassing a mobile phase or the fluidic sample;
the separation unit is configured for retaining the fluidic sample being a part of a mobile phase and for allowing other components of the mobile phase to pass the separation unit;
at least a part of the separation unit is filled with a separating material;
at least a part of the separation unit is filled with a separating material, wherein the separating material comprises beads having a size in the range of 1 μm to 50 μm;
at least a part of the separation unit is filled with a separating material, wherein the separating material comprises beads having pores having a size in the range of 0.02 μm to 0.03 μm;
the flow cell is arranged downstream of the separation unit;
the sample separation system is configured to analyze at least one physical, chemical and/or biological parameter of at least one compound of the fluidic sample;
the sample separation system comprises at least one of the group consisting of a device for chemical, biological and/or pharmaceutical analysis, a capillary electrophoresis device, a liquid chromatography device, and an HPLC device.

19. A method of detecting a fluidic sample in a flow cell of a sample separation system, the method comprising
generating a plasma in a chamber;
generating and directing an energy beam towards the plasma for heating the plasma so that the plasma emits primary electromagnetic radiation;
arranging a detection path in a detection direction, wherein the detection direction is arranged angularly displaced with respect to a propagation direction of the energy beam, so that primary electromagnetic radiation propagating in the detection direction enters the detection path;
detecting, in the detection path, secondary electromagnetic radiation being characteristic for the fluidic sample and resulting from an interaction between the fluidic sample and the primary electromagnetic radiation propagating in the detection direction or at least a portion thereof.

20. A method of detecting a plurality of fluidic samples in flow cells of a sample separation system, the method comprising
emitting primary electromagnetic radiation using an electromagnetic radiation source which source has a chamber configured for generating a plasma, and an energy source configured for generating and directing an energy beam towards the plasma for heating the plasma so that the plasma emits the primary electromagnetic radiation;
arranging each of a plurality of detection paths so that a respective part of the primary electromagnetic radiation enters a respective one of each of the detection paths;
detecting, in each of the detection paths, secondary electromagnetic radiation being characteristic for the respective one of the plurality of fluidic samples and resulting from an interaction between the respective fluidic sample and the respective part of the primary electromagnetic radiation.
